(19) United States
(12) Patent Application Publication
(10) Pub. No.: US 2012/0116836 A1
(43) Pub. Date: May 10, 2012

(54) CONSOLIDATING BUSINESS PROCESS WORKFLOWS THROUGH THE USE OF SEMANTIC ANALYSIS

(75) Inventors: Romelia H. Flores, Keller, TX (US); Charlet N. Givens, Dallas, TX (US); Shiju Mathai, Carrollton, TX (US)

(73) Assignee: INTERNATIONAL BUSINESS MACHINES CORPORATION, ARMONK, NY (US)

(21) Appl. No.: 12/941,307

(22) Filed: Nov. 8, 2010

(51) Int. Cl. G06Q 10/00; G06F 3/048

(52) U.S. Cl. 705/7.27; 715/771

(57) ABSTRACT

A first and a second workflow can be identified. The workflows can be a sequence of connected steps representing work of a business process which can be modeled within a computing environment as an object. The object can be an activity or an event of the business process. A semantic analysis can be automatically performed upon the workflows. The semantic analysis can compare each object of the workflows to each other. An object report can be generated from the comparison which can indicate a similarity and/or a difference between each object of the workflows. The similarity can denote two or more objects are identical and the difference can denote two or more objects are not identical. The workflows can be programmatically consolidated into one or more consolidated roadmap using the object report. The roadmap can be a business process workflow comprised of each unique object of first and second workflow.

### BACKGROUND

The disclosure relates to the field of business process reengineering, and more particularly, to consolidating business process workflows through the use of semantic analysis.

Business processes are an integral part of conducting business and meeting business objectives. Business processes can organize a collection of related, structured activities such as tasks which produce a specific service and/or product (e.g., business objective). For example, business processes can often be visualized as a flowchart and/or workflow of a sequence of activities. Business processes can be modeled through a large number of methods and/or techniques. For instance, the Business Process Modeling Notation (BPMN) is a Business Process Modeling (BPM) technique that can be used for drawing business processes in a workflow. Due to the large number of methods and/or techniques, different notations, organizational structures, and relationships, structurally different workflows can represent the same work. For instance, different companies can often institute different business processes and consequently different workflows to achieve the same business objective.

While there are many tools to model workflows, there are currently no tools to aid business analysts in consolidating multiple workflows to create a single roadmap to consolidate those workflows effectively. This is due to non-standardized nature of workflows which result from enterprise specific business processes and/or vendor specific tooling. Consequently, business analysts must manually review each business process workflow manually and perform the consolidation process without the aid of automated tools.

### SUMMARY

Business process workflows associated with similar business processes can be unified into a consolidated business process by utilizing a roadmap framework. The roadmap framework can utilize semantic analysis to determine differences and similarities within the business process workflows and to generate an object report which can include multiple types of information about the business process workflows (e.g., list and order of steps). In one embodiment, the object report can denote common objects which are shared by the workflows such as objects which have different identifiers, but are semantically identical. For instance, object report can be used to discover an object named “CSR” in one workflow is the same object type as an object named “Service Rep” in another workflow. The object report can be iteratively refined within the roadmap framework to produce a finalized business process meeting business requirements.

### BRIEF DESCRIPTION OF THE SEVERAL VIEWS OF THE DRAWINGS

FIG. 1 is a flowchart illustrating a method for merging business process workflows into a consolidated business process using semantic analysis in accordance with an embodiment of the inventive arrangements disclosed herein

FIG. 2 is a schematic diagram illustrating a system for consolidating business process workflows using semantic analysis in accordance with an embodiment of the inventive arrangements disclosed herein.

FIG. 3 is a schematic diagram illustrating a sample object report within an interface for consolidating business process workflows in accordance with an embodiment of inventive arrangements disclosed herein.

### DETAILED DESCRIPTION

The disclosure presents a solution for consolidating business process workflows by utilizing RoadMap framework. In the solution, commonalities (e.g., steps, objects) between workflows can be identified through semantic analysis of the workflows. The commonalities (e.g., and differences) can be compiled into an object report which can be analyzed to create a final consolidated business process. During the semantic analysis, metadata associated with the workflow and constituent objects can be obtained. In one instance, a social network can be searched for metadata associated with a workflow object to determine similar objects. For example, a Web log can be probed to determine synonyms for an object tag. The object report created from the semantic analysis can be presented within a user interface. For instance, the object report and/or roadmap can be presented within a roadmap dashboard permitting customization of the roadmap.

As will be appreciated by one skilled in the art, the disclosure may be embodied as a system, method or computer program product. Accordingly, the disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the disclosure may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

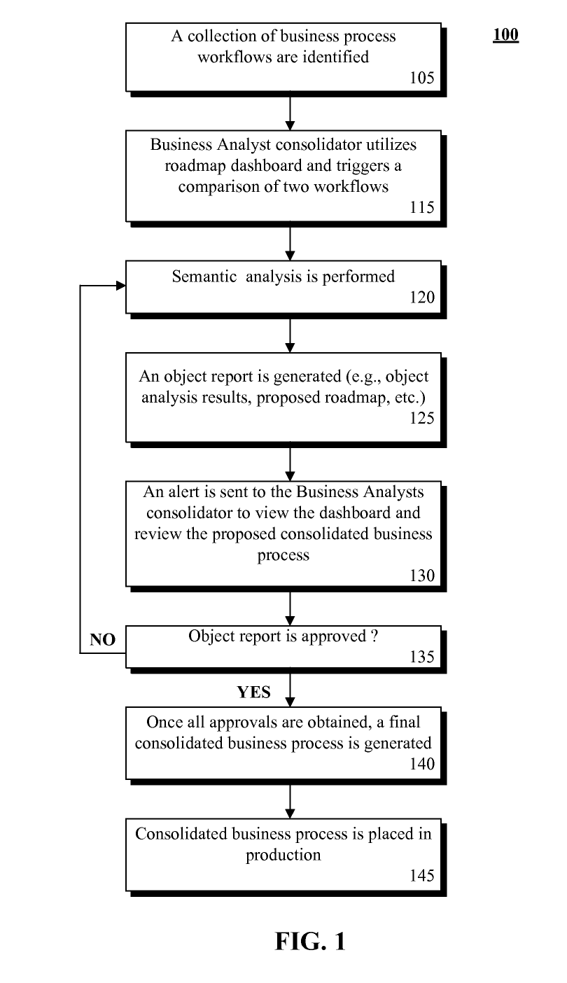

FIG. 1 is a flowchart illustrating a method 100 for merging business process workflows into a consolidated roadmap in accordance with an embodiment of inventive arrangements disclosed herein. In method 100, a collection of similar business process workflows can be identified and consolidated through the use of a semantic analysis which can employ automatically collected and/or user provided metadata. Method 100 can be performed in the context of system 200. It should be appreciated that method 100 can be implemented within a roadmap framework of the disclosure.

As used herein, a workflow or business process can be a sequence of connected steps representing work associated with a business. A Business process which can include, but is not limited to, a management process, operational process, supporting process, and the like. Business process can comprise of activities, sub-processes, and the like.

As used herein, business process workflows can be two or more workflows modeled with different and/or similar notations. Notations can include, but are not limited to Business Process Management Notation (BPMN), Unified Modeling Language, and the like. For example, workflows from different departments of an enterprise can be consolidated into a single unified business process. In one instance, the disclosure can permit the consolidation of similar workflows utilizing different notations. For example, a workflow A can be modeled utilizing a BPMN tool and a workflow B can be engineered using a UML application.

Semantic analysis can be performed on the workflows to determine similarities and differences between each workflow, workflow objects, workflow sub-processes, and the like. The analysis can be compiled into an object report which can be utilized to iteratively improve the final consolidated roadmap. The report can be subject to additional analysis which can result in modifications to the report. The Consolidated business process can be submitted to business process management (BPM) tools which can execute the consolidated business process. It should be appreciated, no current tooling is currently available which permits automated consolidation of semantically similar workflows. The disclosure reveals a solution to address the absence of utilities programmatically by identifying common workflow objects (e.g., activity, steps, objects), consolidating the common workflow objects, and reengineering a consolidated workflow.

It should be understood, the disclosure provides an iterative approach to creating a consolidated roadmap from non-homogenous and homogenous workflows. In one instance, a consolidated roadmap can undergo user reviews (e.g., business analyst reviews) during an iterative process. In the instance, users can enable optimization of a consolidated roadmap to occur through continuous user input.

In one embodiment, the collection of workflows can be merged into a smaller working set of consolidated workflows. In another embodiment, the collection of workflows can be consolidated into a single unified workflow such as a roadmap. In yet another embodiment, the collection of workflows can be merged into a working set of production workflows.

In step 105, a collection of business process workflows can be identified. For practical purposes, the collection of workflows can be referred to as the workflows hereafter. Identification of the workflows can be programmatically determined and/or can be manually selected. In one instance, workflows can be identified automatically using configuration settings, discovery rules, and the like. Workflow data can be collected for each workflow. Workflow data can include, but is not limited to workflow tags, workflow weight metrics, and the like. In step 115, a Business Analyst consolidator can utilize the roadmap dashboard to trigger a comparison of two workflows.

In step 120, semantic analysis of the workflows can be performed utilizing collected data. Semantic analysis can utilize one or more tools including, but not limited to semantic analysis tools, text analysis tools, data mining tools, semantic indexing tools, and the like. Analysis can be performed utilizing one or more tools including, but not limited to IBM SPSS, Concurrent Object-Based Real-time Analysis (COBRA) tooling, and the like. It should be appreciated, semantic tools can include internal and external tooling resources. In step 125, an object report can be generated in response to the semantic analysis. In one instance, the object report can include, but is not limited to, semantic analysis results, a tentative roadmap, and the like.

In step 130, the object report can be sent to the Business Analyst consolidator, who is able to view the dashboard and review the proposed consolidated business process for approval. The object report can be presented to one or more users via a user interface, notification event, and the like. In one scenario, notification can be performed via one or more mechanisms including, but not limited to, electronic mail, Short Message Service, voice call, Instant Message (IM), and the like. In one instance, permission settings (e.g., owner, group) can be utilized to present the object report to an appropriate user and/or group. In one instance, the object report can be distributed to one or more social networking outlets including, but not limited to, a Web log, a social networking site, a Wiki, and the like. In another instance, object report can be presented within a customized interface such as a roadmap dashboard. User feedback associated with the object report can be directly obtained. In one instance, automated feedback collection can be integrated into one or more interfaces (e.g., roadmap dashboard, Wiki). Feedback can include, but is not limited to, user comments, user ratings, and/or user modifications. User modifications can include, but are not limited to, adding objects, removing objects, manipulating objects, and the like. It should be appreciated manual user approval can be eliminated in the presence of sufficiently sophisticated semantic analysis and/or adequate metadata.

In step 135, if the object report is approved the method can continue to step 140, else return to step 120. Approval of the object report can include automated and manual validation procedures which can verify one or more portions of the object report for inputs, outputs, syntax, organization, semantics, and the like. Approval can be governed by configuration settings, global policies, local policies, and the like. In one instance, object report can be modularly approved enabling selective revisioning of the report contents. In step 140, a consolidated business process can be generated once all necessary approvals have been obtained. The consolidated roadmap can conform to a notation which can be programmatically and/or manually chosen. For example, two differently notated workflows can be combined into a consolidated roadmap which can be defined using a third different notation. In one instance, the consolidated roadmap can be subject to user approval/review prior to continuation of the method. In step 145, the consolidated roadmap can be placed to a production system (e.g., workflow management system) to be executed. Execution can be performed within a sandbox, virtual environment, and the like. In one instance, execution metrics can be collected for each step of the consolidated roadmap. Metrics can include, but is not limited to, distance metrics, execution time, activity time, response time, and the like. It should be noted that metrics can be collected from BPM tools and can be an external resource which can be leveraged to optimize the consolidated roadmap.

Business process report of the consolidated workflow execution can be generated. The report can include, but is not limited to, metrics, similarity scores, and the like. The report can be a text document, Hypertext Markup Language (HTML) document, Extensible Markup Language (XML) document, and the like.

Drawings presented herein are for illustrative purposes only and should not be construed to limit the disclosure in any regard. It should be understood method 100 is only one contemplated embodiment of the disclosure; other embodiments are contemplated. Method 100 can be a continual iterative process which can occur throughout an enterprise life-span. In one instance, steps 120-135 can be repeatedly executed to enable an optimized consolidated roadmap to be generated. In the instance, optimizations can be used to improve the accuracy of the semantic analysis and/or metadata to enable intelligent evolution of the semantic analysis and accurate consolidated workflows.

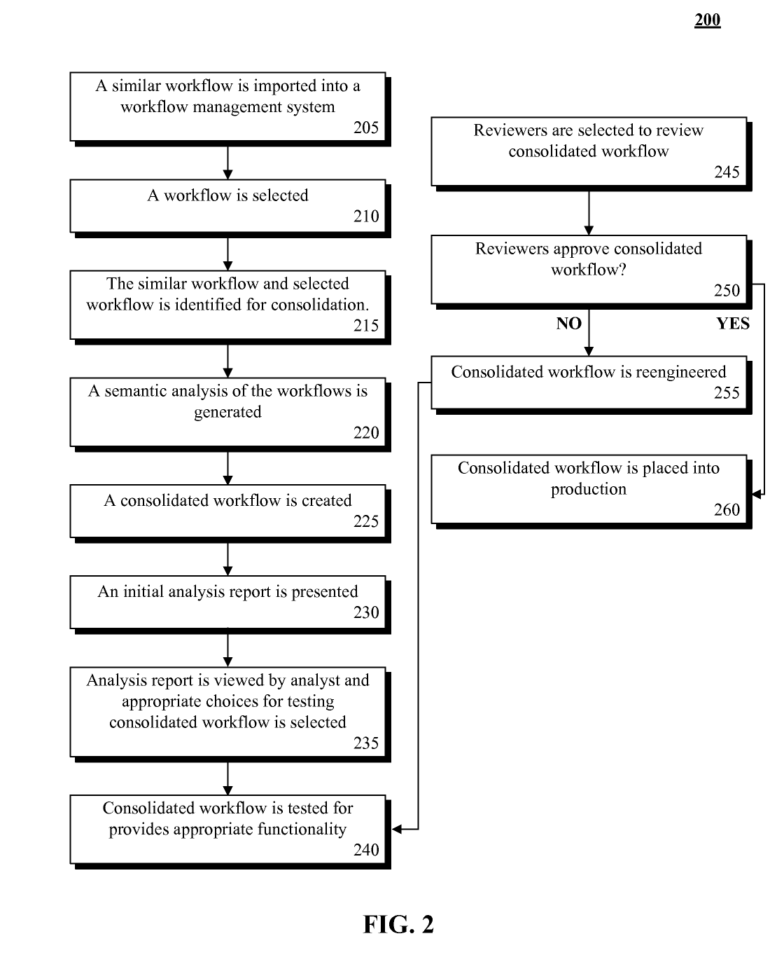

FIG. 2 is a schematic diagram illustrating a system 200 for consolidating business process workflows using semantic analysis in accordance with an embodiment of inventive arrangements disclosed herein. System 200 can be one embodiment of an infrastructure enabling method 100 and presentation of object report 300. System 200 can be communicatively linked to business process management server 250 and social network 240 via network 270. System 200 can be communicatively linked to other network components, services, and/or systems including, but not limited to, directory services, analytic tools, reporting tools, repositories, and the like.

In one embodiment, system 200 can include traditional workflow functionality and the novel functionality described herein. System 200 can be integrated within one or more existing workflow management frameworks. In one embodiment, system 200 functionality can be a plug-in component of a workflow management system. In another embodiment, system 200 functionality can be encapsulated as a Web service. In yet another embodiment, roadmap framework 210 can be a component of business process management (BPM) server 250.

In system 200, an object report 228 can be generated by roadmap engine 220 which can enable consolidated roadmap 238 to be generated. In one instance, the object report 228 can be generated. Metadata 230 (e.g., semantic tags and filters) can continually evolve using semantic information obtained from programmatic sources (e.g., roadmap engine 220) and/or user agents. Semantic information can be obtained from additional sources including, but not limited to, BPM tool 252, social artifacts 242-248, and the like. For instance, tag information which describes similar and/or dissimilar workflow objects can be obtained from social artifacts 242-248.

For example, metadata repository 232 can store tags and possible synonyms which can aid the accuracy of the semantic analysis. This can be accomplished by the choice of filters depending on the type of analytics product used. Repository 232 can be dynamically updated during the process enabling manual intervention to decrease over time. Further, profile 225 can be utilized to discover tags from other sources which can be user specified.

As used herein, consolidated roadmap 238 can be a business process workflow comprising of one or more elements (e.g., objects) from two or more workflows 226. Consolidated roadmap 238 can be defined using business process management notation (BPMN), Unified Modeling Language (UML), Event-driven process chain (EPC), and the like. In one instance, consolidated roadmap 238 can be constructed from a business process management programming language Business Process Execution Language (BPEL). Consolidated roadmap 238 can be stored within a metadata repository 232, data store, data stores associated with framework 210, BPM server 250, and the like. It should be appreciated, consolidated roadmap 238 can refer to one or more consolidated workflows, consolidated workflow sub-processes, and the like.

Roadmap framework 210 can be a hardware/software component for generating, managing, and optimizing object report 228 and/or consolidated roadmap 238. Framework 210 can be comprised of roadmap engine 220, workflow 226, object report 228, repository 232, interface 234, and the like. Framework 210 can enable management of consolidated roadmap 238, workflow 226, and the like. Framework 210 can permit cyclical roadmap improvement of consolidated roadmap 238 within the traditional arenas of effectiveness, efficiency, internal control, and compliance. Framework 210 can utilize standard and/or proprietary roadmap management mechanisms to generate, manage, and optimize consolidated roadmap 238.

Roadmap engine 220 can be a hardware/software component for consolidating workflow 226 into one or more consolidated roadmaps. Engine 220 can be comprised of, but is not limited to, roadmap generator 221, analytics engine 222, notification handler 223, social network search engine 224, profiles 225, and the like. Engine 220 can utilize traditional and/or proprietary algorithms to enable consolidation of workflows. Engine 220 can be extensibly configured via one or more profile 225 settings, configuration settings, and the like.

Object report 228 can be an artifact comprising of semantic analysis results which can be utilized to generate a consolidated roadmap 238. Report 228 can be comprised of, but is not limited to, workflow activities, timestamp, metrics, progress value, a similarity score, a user comments, a user rating, a metadata tag, a workflow language, an activity execution time, a process execution time, a response time, and the like. In one instance, object report 228 can be a Hypertext Markup Language (HTML) document. For instance, object reports 228 can be accessible via a Uniform Resource Locator (URL). In one embodiment, report 228 can conform to a Resource Description Framework. Report 228 can be arbitrarily complex and can be comprised of multiple degrees of granularity, including, but not limited to, activity, sub-process, process, and the like. In one instance, report 228 can be comprised of workflow similarity information. In the instance, the similarity of each object (e.g., workflow activity) within workflows 226 can be computed. For instance, metadata 236 can be used to discover tags identified by the label “Street” within a workflow A can be identical to tags labeled “Street Address” and “Address Line 1” within a workflow B. It should be appreciated, object report 228 can be generated utilizing traditional and/or proprietary algorithms, including, fuzzy logic algorithms, difference matching algorithms, and the like. In one embodiment, object report 228 can include metadata tags which can provide additional semantic information for workflow elements.

Roadmap generator 221 can be a hardware/software component able to analyze object report 228 and consolidate multiple workflows into a consolidated roadmap 238. Generator 221 can utilize metadata within object report 228 to model and/or optimize a consolidated roadmap 238. Generator 221 can communicate with components 222-225, to enable consolidated roadmap management, execution, and/or optimization. Generator 221 can be configured to respond to various occurrences during the management of roadmap. Occurrences can include, but is not limited to, workflow analysis, management actions performed on workflows, roadmap execution, and the like. That is, generator 221 can be flexibly configured to respond to triggers which can enable intelligent automation. In one instance, generator 221 can be a component of a workflow orchestration engine.

Analytics engine 222 can be a hardware/software component able to semantically analyze workflow 226 and/or object 228. Engine 222 can identify, analyze, and/or aggregate workflow 226 semantic information. Engine 222 can conform to traditional and/or proprietary semantic algorithms. Engine 222 can be utilized to compare workflows objects, steps, sub-processes and the like. In one instance, engine 222 analysis can be configurable enable granularity control. In one embodiment, engine 222 can utilize engine 224 to obtain metadata (e.g., tags, filters) to improve semantic analysis. For example, engine 222 can be a component of a Semantic Web environment.

Notification handler 223 can be a hardware/software component permitting notification of activities affecting workflows within system 200. Notification handler 223 can be configured using triggers, policies, rules, and the like. Handler 223 can include, but is not limited to, user notifications, component messaging notification, and the like. User notification can include, but is not limited to, visual interface messages, auditory interface messages, and the like. For example, user notification can include an email indicating an object report 228 is ready for review. In one instance, user notifications can be presented within interface 234.

Social network search engine 224 can be a hardware/software component able to search for metadata (e.g., tags) and additional filters. In one instance, engine 224 can search a Web resource for metadata tags and filters. In another instance, engine can be utilized to convey the object report and/or roadmap to a social network 240. In the instance, user feedback (e.g., comments) can be obtained from the social network 240 and be utilized to improve semantic analysis results. That is, engine 224 can utilize social network 240 components, Web site 242, Wiki 244, Web applications 246, Web Log 248, and the like, to obtain user provided semantic information to enhance object report 228. Engine 224 can include lexicographic tools, semantic analysis tools, text analysis tools, data mining tools, semantic indexing tools, and the like. For instance, tag information can be obtained from elements 242-248 to identify common workflow activities. It should be noted, engine 224 can be an optional component of system 210, which can be communicatively linked to aid framework 210.

Profiles 225 can be one or more automatically and/or manually established entities for affecting the behavior of framework 210 and/or constituent components. Profiles 225 can include, but is not limited to, rules, policies, semantic information, filters, and the like. In one instance, objects and tags obtained from social network 240 can be stored within filters linked to profile 225, within metadata repository 232, and the like. In another instance profiles 225 can be user established profiles enabling user specific customized settings for interacting with framework 210. In yet another instance, profiles can be used to setup user defined filters which can establish workflow activity equivalencies. For example, a filter can be used to indicate that <Notification Type> is equivalent to <Contact Type>. Further, profiles 225 can be used to establish preferred naming schemes.

Interface 234 can be a hardware/software component for interfacing within framework 210. Interface 234 can be a user interface including, but not limited to, graphical user interface (GUI), voice user interface (VUI), mixed-mode interface, and the like. In one instance, a consolidated roadmap 238 can be presented within interface 234. In the instance, the user interface can be comprised of analysis information and/or execution information (e.g., metrics). In one embodiment, interface 234 can be a screen of a roadmap dashboard interface.

Repository 232 can be a locally and/or remotely connected element of framework 210. Repository 232 can include, but is not limited to, a network attached storage (NAS), a storage area networks (SAN), a hard drive, and the like. Repository 232 configurations can include, but is not limited to, relational database management system (RDBMS), object oriented database management system (OODBMS), and the like.

Drawings presented herein are for illustrative purposes only and should not be construed to limit the disclosure in any regard. Framework 210 can be a component of a service oriented architecture (SOA), model-driven architecture (MDA), application programming interface (API), and the like. Framework 210 can be a component of distributed computing system, network computing system, and the like. Further, it should be appreciated, framework 210 can enable partial consolidation of workflows. For instance, controlled consolidation of portions of workflows can be achieved through the use of framework 210. It should be understood that workflow 226 can be stored within repository 232, a local and/or remote data store, within BPM server 250, and the like. Further, it should be appreciated social network 240 can include one or more social network structures, internal blogs, wikis, industry blogs, and forums including, but not limited to LINKEDIN, FACEBOOK, and the like.

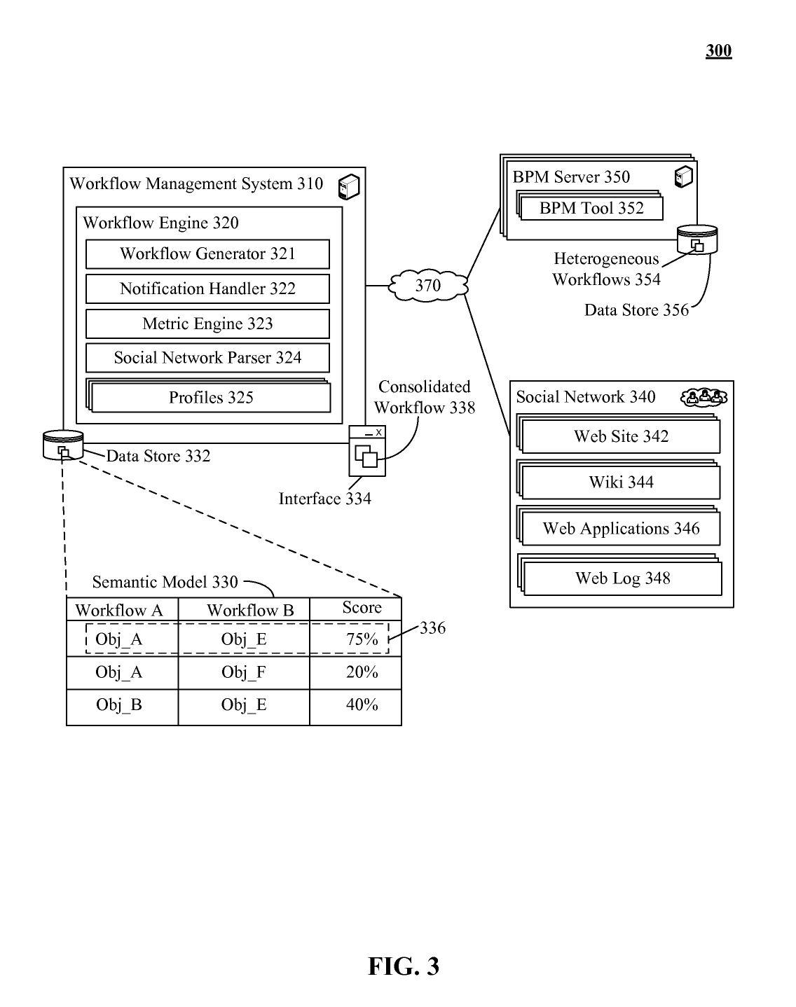

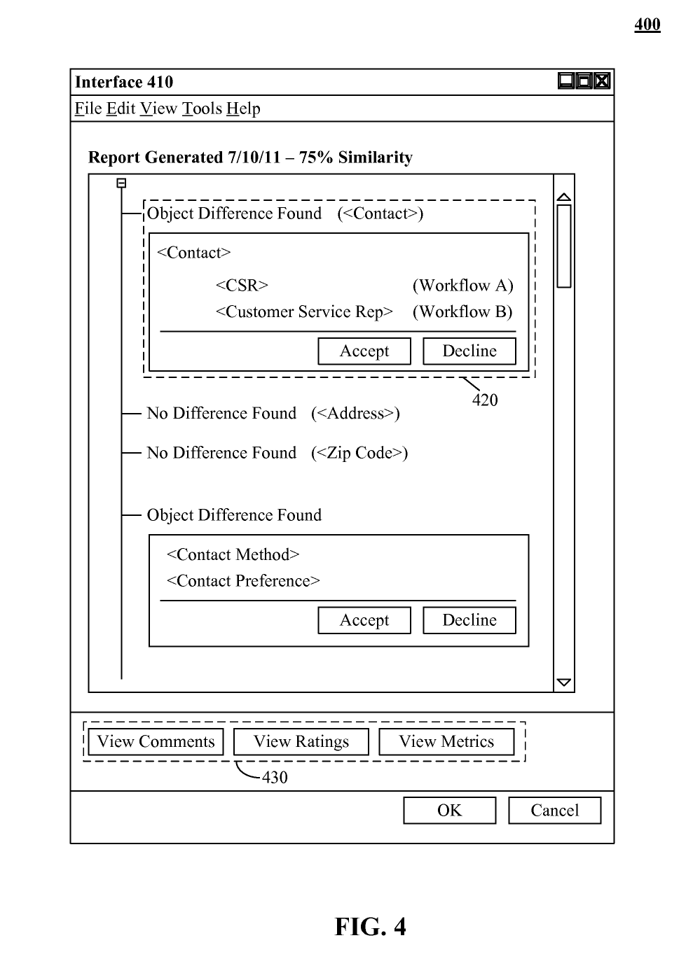

FIG. 3 is a schematic diagram illustrating a sample user interface dashboard 310 for consolidating business process workflows in accordance with an embodiment of inventive arrangements disclosed herein. In interface 310, a sample user interface comprising of semantic analysis results can be presented. Interface 310 can permit user input to drive consolidated roadmap generation. Interface 310 can be a user interface able to present semantic information associated with a workflow analysis. Interface 310 can permit consolidated workflow management, roadmap presentation, and the like. In one instance, interface 310 can be associated with a workflow management system.

In section 320, an itemized workflow object analysis can be presented within the interface 310. Section 320 can include, but is not limited to, object information, similarity score, object metadata (e.g., tags), and the like. In one instance, section 320 can present similar objects from two or more workflows. In the instance, user interface artifacts can permit a manual decision making processes to occur. For instance, interface elements (e.g., accept/decline) can be presented to allow a user to control which objects can be established as semantically similar and/or different.

In section 330, interface elements can be presented within the interface 310 to enable viewing of user comments, ratings, metrics associated with a workflow and/or workflow analysis, and/or tentative roadmap information. Elements within section 330 can allow a user to review comments, ratings, metrics, roadmaps which can assist the user in the decision making process. Comments, ratings, and/or metrics can be associated with a social network, data store, and the like. That is, section 330 can permit easy access to supporting information associated with a workflow analysis.

In one instance, interface 310 can permit dissemination of consolidated workflow reports, user comments, ratings, and the like. In the instance, social networks can be automatically updated with workflow information in response to a user action. For instance, interface 310 can present a “publish to company Web log” interface element, permitting automated publishing of an object report. In one embodiment, interface 310 can allow a user to easily resubmit a consolidated workflow for optimization and/or improvement.

Drawings presented herein are for illustrative purposes only and should not be construed to limit the disclosure in any regard. Interface elements can include, but are not limited to, interface push-button, drop-down box, radio selection, check box, and the like. Functionality of interface 310 described herein, can be presented within a pull-down menu, context menu, and the like. In one embodiment, interface 310 can be a generic interface not associated with a workflow management system. For instance, interface 310 can be a Web browser presenting a Hypertext Markup Language (HTML) formatted consolidated workflow report.

The flowchart and block diagrams in the FIGS. 1-3 illustrate the architecture, functionality, and operation of possible implementations of systems, methods and computer program products according to various embodiments of the disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for consolidated roadmap generation comprising:
identifying a first and a second workflow, wherein the first and second workflow is a sequence of connected steps representing work of a business process, wherein each step of the sequence of connected steps is modeled within a computing environment as an object, wherein the object is at least one of an activity and an event of the business process, wherein the first and second workflow is comprised of a plurality of the object;
automatically performing a semantic analysis upon the first and second workflow, wherein the semantic analysis compares each object of the first workflow with each object of the second workflow;
generating an object report associated with the first and second workflow, wherein the object report indicates at least one of a similarity and a difference between each object of the first workflow and each object of the second workflow, wherein the similarity denotes an object of the first workflow is identical to an object of a second workflow, wherein the difference denotes an object of the first workflow is not identical to an object of the second workflow; and
programmatically consolidating the first and second workflow into at least one consolidated roadmap using the object report, wherein the roadmap is a business process workflow comprising of each unique object of the first and second workflow.

2. The method of claim 1, further comprising:
presenting the object report within a user interface, wherein the user interface is a roadmap dashboard, wherein the roadmap dashboard is a graphical user interface for managing at least one of the object report and the consolidated roadmap.

3. The method of claim 1, further comprising:
presenting user interface with the object report, dashboard for the execution metrics, and having user comment, a user specified tag, and a user rating.

4. The method of claim 1, further comprising:
collecting at least one metadata tag from a social network associated with an object of either the first and the second workflow, wherein the metadata tag is a keyword tag, wherein the social network is social structure comprising of at least two nodes, wherein the nodes are connected by at least one specific type of interdependency; and
conveying at least one metadata tag to an entity performing the semantic analysis.

5. The method of claim 4, wherein the social network is a user specified social network, wherein the user specified social network is stored within a user profile.

6. The method of claim 4, wherein the collecting is obtained from at least one of a Web site, a Web Log, a Wiki, a forum, and a Web application.

7. The method of claim 1, wherein each object of the consolidated roadmap is associated with at least one of a progress value, a similarity score, a user comment, a user rating, a metadata tag, a workflow language, an activity execution time, a process execution time, and a response time.

8. The method of claim 1, further comprising:
receiving a user interface with object report, dashboard associated with the consolidated roadmap, having at least one of a user comment, a user specified tag, a user approval indicator, and a user rating; and
notifying a user associated with the consolidated roadmap.

9. The method of claim 1, further comprising:
determining an aggregate score associated with the first workflow and the second workflow, wherein the aggregate score indicates the similarity between the first workflow and the second workflow.

10. A method for generating a consolidated roadmap comprising:
identifying a programmatically generated consolidated roadmap within a roadmap framework, wherein the roadmap framework is an entity comprising of a business process workflow, an object report, and a consolidated roadmap, wherein the business process workflow is a sequence of connected steps representing work of a business process, wherein each step of the sequence of connected steps is modeled within a computing environment as an object, wherein the object is at least one of an activity and an event of the business process;
receiving a feedback artifact associated with the object report, wherein the feedback artifact is at least one of a user specified alteration and a determined adjustment;
modifying the object report based on the received feedback artifact.

11. The method of claim 10, further comprising:
automatically performing a semantic analysis on metadata associated with the object report.

12. A system for generating a consolidated roadmap comprising:
a processor;
a volatile memory;
a bus connecting said processor, non-volatile memory, and volatile memory to each other, wherein the volatile memory comprises computer usable program code execute-able by said processor, said computer usable program code comprising:
a roadmap generator configured to generate a consolidated roadmap from a plurality of business process workflows, wherein each of the plurality of workflows is a sequence of connected steps representing work of a business process, wherein each step of the sequence of connected steps is modeled within a computing environment as an object, wherein the object is at least one of an activity and an event of the business process;
an analytics engine configured to perform a semantic analysis on the plurality of business process workflows, wherein the semantic analysis identifies unique objects of the plurality of business process workflows, wherein the semantic analysis produces an object report, wherein the object report comprises of at least one of a unique object identified by the semantic analysis, a tentative roadmap, and a metadata associated with the business process workflow;
a social network search engine able to perform networking actions within a networked environment, wherein the networked environment comprises of entities, wherein the entities is at least one of a social network, a Web site, a Wiki, a forum, a Web Log, and a Web application; and
a metadata repository capable of storing metadata associated with at least one of the business process workflow and the analytics engine, wherein the metadata is at least one of a keyword tag, a keyword tag synonym, and a filter.

13. The system of claim 12, wherein the networking actions comprise of collecting semantic information associated with the plurality of business process workflows, wherein the semantic information is at least one of a keyword tag and a filter.

14. The system of claim 12, wherein the networking actions comprise of conveying the object report to at least one entity within the networked environment.

15. The system of claim 12, wherein the networking actions comprise of receiving at least one review artifact associated with the object report, wherein the review artifact is at least one of a user comment, a user specified tag, a user approval indicator, and a user rating.

16. The system of claim 12, further comprising:
a user profile configured to store at least one of a user preference, an object, and a keyword tag obtained from the social network search engine.

17. The system of claim 12, further comprising:
a roadmap dashboard able to present at least one user interface containing at least one consolidated roadmap, wherein the roadmap dashboard is a highly configurable user interface.

18. The system of claim 12, wherein the roadmap generator optimizes the consolidated roadmap based on feedback associated with the object report, wherein the feedback is at least one of a determined input or user input.

19. The system of claim 12, wherein the object report conforms to a Resource Description Framework (RDF) or other standard formats.

20. The system of claim 12, wherein the metadata is at least one metric is associated with a business process workflow, wherein the metric is at least one of a progress value, a similarity score, a user comments, a user rating, an activity execution time, a process execution time, and a response time.
